(19) United States
(12) Patent Application Publication
(10) Pub. No.: US 2023/0329946 A1
(43) Pub. Date: Oct. 19, 2023

(54) MEDICAL SUPPLY CART SYSTEM

(71) Applicant: BIA-PWR LLC, North Kansas City, MO (US)

(72) Inventors: Edward Carl Collins, Olathe, KS (US); David Harold Bishop, Framingham, MA (US); Travis Budenbender, Shawnee, KS (US); Brent Edward Smith, Weston, MO (US)

(21) Appl. No.: 17/719,940

(22) Filed: Apr. 13, 2022

(51) Int. Cl. A61G 12/00; B62B 3/00; B62B 3/02; B62B 5/00

(52) U.S. Cl. CPC A61G 12/001; B62B 3/003; B62B 3/004; B62B 3/005; B62B 3/02; B62B 5/0053; B62B 5/0056; B62B 5/0059; B62B 2204/04

(57) ABSTRACT

A medical supply cart system comprising a cart, a refrigeration device, and a power system. The cart includes an enclosure, a handle, a number of wheels rotatably mounted to the enclosure, and a number of supports each configured to be shifted between an operational position and an access position. The refrigeration device is configured to be positioned in the enclosure and retain perishable medical supplies at a lowered temperature. The power system is configured to power the refrigeration device and includes a number of batteries configured to directly power the refrigeration device, a genset configured to charge the plurality of batteries, and a solar array configured to charge the plurality of batteries.

### BACKGROUND

Perishable medical supplies often cannot be transported or delivered to remote areas, or they have a high percentage of spoilage. This is particularly problematic for cures of pandemic diseases such as Covid-19. Distribution and use of medical supplies can also be difficult to track, which makes it difficult to determine the need for additional medical supplies.

### SUMMARY

Embodiments of the invention solve the above-mentioned problems and other problems and provide a distinct advancement in the art of medical supply systems. More particularly, the invention provides a medical supply cart system that allows perishable medical supplies to be stored, transported, and delivered more effectively and efficiently.

An embodiment of the invention is a medical supply cart system broadly comprising a cart, a refrigeration device, a power system, and a communication module. The medical supply cart system is configured to provide mobile refrigeration for perishable medical supplies.

The cart includes an enclosure, a number of wheels, a drive motor, a number of lift points, a handle, a number of movable supports, and a number of controls. The enclosure includes a number of doors and may be substantially metal, plastic, composite material, wood, or any other suitable material. The doors allow access the refrigeration device , certain components of the power system, and in some embodiments the communication module, electrical wiring, and electronic components.

The wheels are rotatably connected to the enclosure and may be fixed-axle wheels, steerable wheels, or free-turning caster wheels. The drive motor is drivably connected to some of the wheels for propelling the cart. The drive motor may be powered by components of the power system. The lift points provide safe structure for lifting or hoisting the cart. The lift points may include lift rings, eye hooks, forklift tine channels, and the like.

The handle is positioned on one end of the cart and may be rigidly connected to the enclosure or may be pivotably or freely linked thereto. The handle may include controls or inputs for controlling the drive motor, for steering the cart, and/or for controlling various components of the medical cart.

The movable supports support the refrigeration device and certain components of the power system and may be slide-out or rotatable trays, drawers, or the like. The movable supports may be shiftable between a stored position and an access position to make various components more accessible.

The controls may be positioned near the respective component they control or monitor. For example, some of the controls may be positioned near the genset, other ones of the controls may be positioned near the batteries, while other ones of the controls may be positioned near the refrigeration device. The controls may include switches, buttons, dials, knobs, levers, display screens, touchscreens, mouses, keypads, gauges, indicator lights, speakers, and the like.

The refrigeration device may be configured to retain perishable medical supplies at a lowered temperature or lowered temperature range. In one embodiment, the refrigeration device may be configured to retain some of the perishable medical supplies in a first lowered temperature range and some of the perishable medical supplies in a second lowered temperature range different than the first lowered temperature range. In other embodiments, two refrigeration devices configured to retain perishable medical supplies at different lowered temperature ranges than each other may be used. The refrigeration device may be powered by the batteries or directly (i.e., not via the batteries) by the genset or the solar array (described below). The refrigeration device may also be powered directly or indirectly by external power via an external power connection, which may be an electrical outlet or other electrical interface.

The power system provides electrical power to the refrigeration device, the communication module, and other electrical and electronic components and may include a number of batteries, a genset, and a solar array.

The batteries store electrical energy for powering the refrigeration device. The batteries may be lithium, alkaline, or metal hydride batteries, super capacitors, or any other suitable electrical energy storage component. The batteries may also provide electrical power to the communication module, the drive motor, auxiliary lights, auxiliary power outlets, and the like. The batteries may also be charged by line voltage (via an electrical outlet or other electrical connection).

The genset may include an engine and generator and may be configured to charge the plurality of batteries. The genset may also provide electrical power directly to the refrigeration device (rather than first storing the electrical power in the plurality of batteries). The genset may also provide electrical power to the communication module, the drive motor, auxiliary lights, auxiliary power outlets, and the like. The genset may be configured to be run on gasoline, diesel fuel, natural gas, propane, or any other suitable fuel. To that end, a fuel tank may be mounted in, on, or near the enclosure to provide fuel to the genset.

The solar array may be mounted near a top of the enclosure and may include a stationary section and a movable section each including one or more solar panels. The stationary section may be rigidly connected to the enclosure, while the movable section may be shiftable between a stored position and a deployed position.

The communication module may generally allow components of the medical supply cart system to communicate with, transfer data to, and download software updates, programming, and direct commands from a remote server, cloud service, or other external system, mobile electronic devices, and the like. The communication module may include signal and/or data transmitting and receiving circuits, such as antennas, amplifiers, filters, mixers, oscillators, digital signal processors (DSPs), and the like.

The medical supply cart system 100 may also include other electrical and electronic components such as connecting wires, busses, converters, inverters, fuses, circuit breakers, and electrical outlets. The medical supply cart system 100 may also include other mechanical components such as valves, pumps, fuel regulators, lubricating systems, cooling systems, heating elements, radiators, and the like.

The above-described medical supply cart system provides several advantages. For example, the medical supply cart system may be used to refrigerate medical supplies such as vaccine dosages including Covid vaccine dosages to provide medical care in remote or mobile environment. The medical supply cart system includes several power options to accommodate local energy source availability. The medical supply cart system may also serve as a “hot spot” via the communication module. The communication module may also be used to transmit, to remote or external computing devices, data relating to the refrigeration device such as current temperature and number of medical supplies current stored or provided. The medical supply cart system may also be used as an electrical power station or even a mechanical power station via the engine of the genset.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a medical cart system constructed in accordance with an embodiment of the invention;

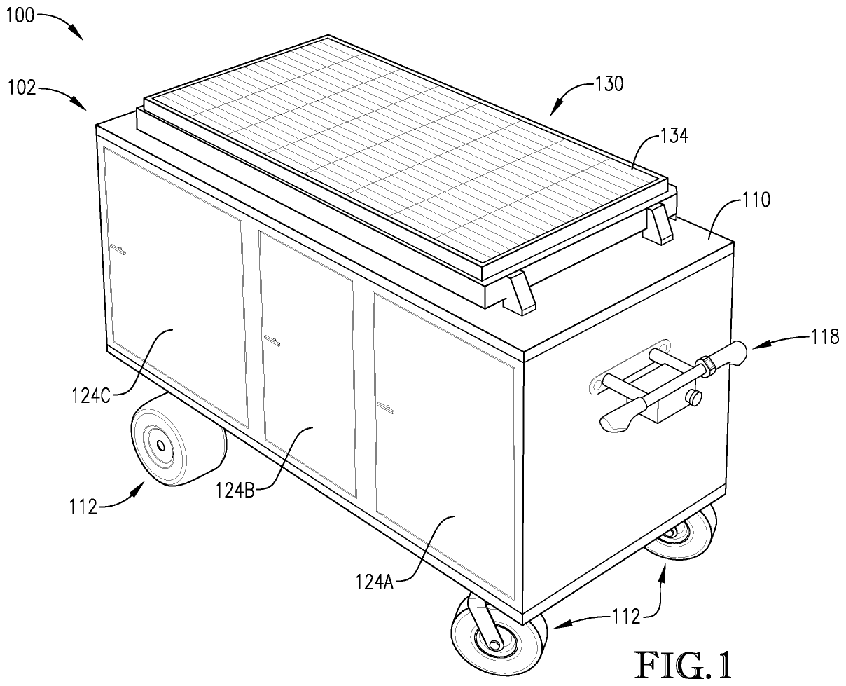

FIG. 2 is another perspective view of the medical cart system of FIG. 1;

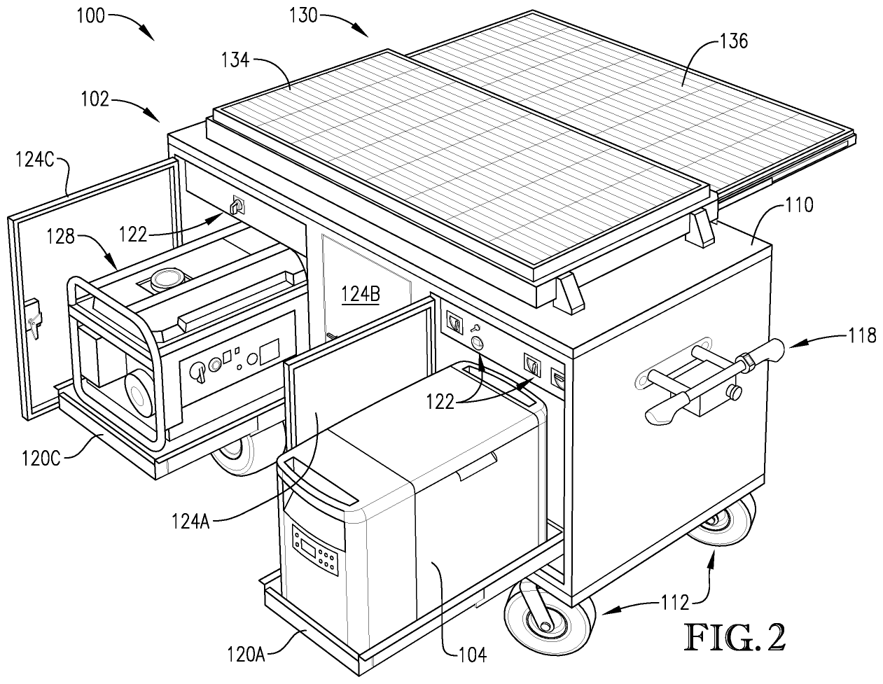

FIG. 3 is another perspective view of the medical cart system of FIG. 1;

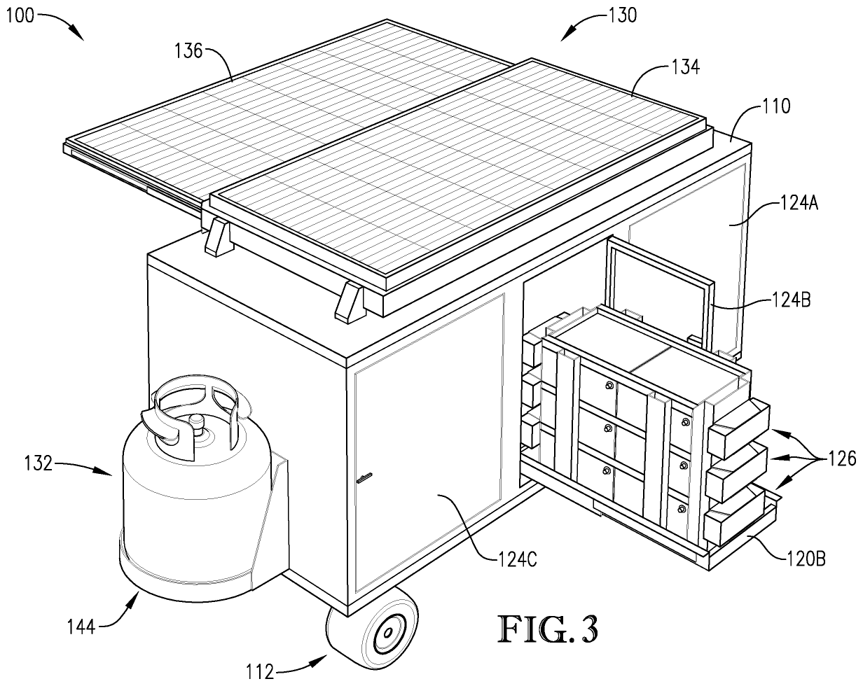

FIG. 4 is a side elevation view of the medical cart system of FIG. 1; and

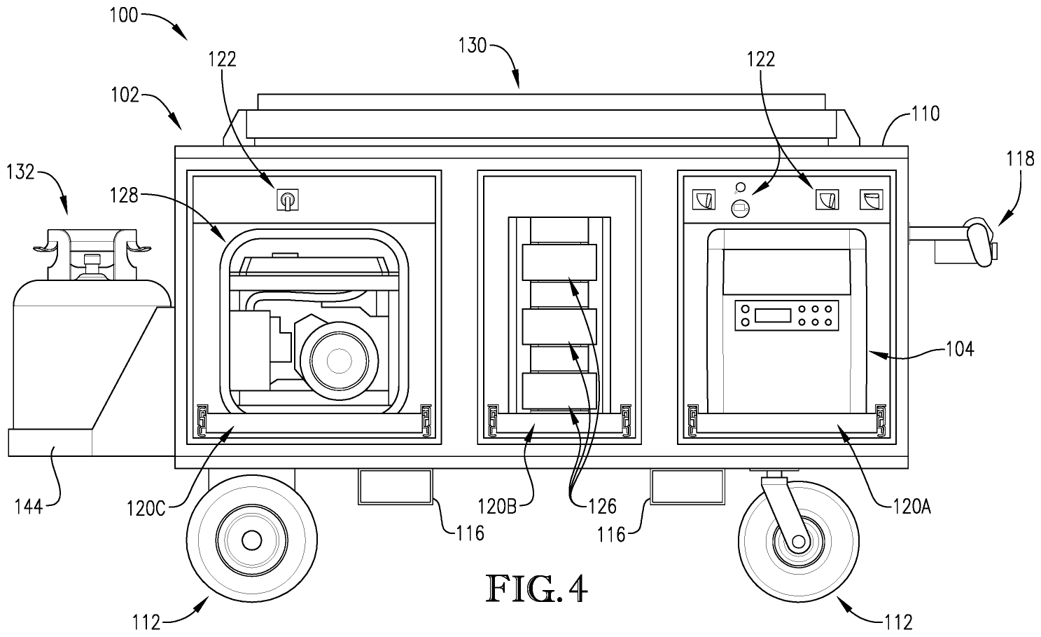

FIG. 5 is a schematic diagram of certain components of the medical cart system of FIG. 1.

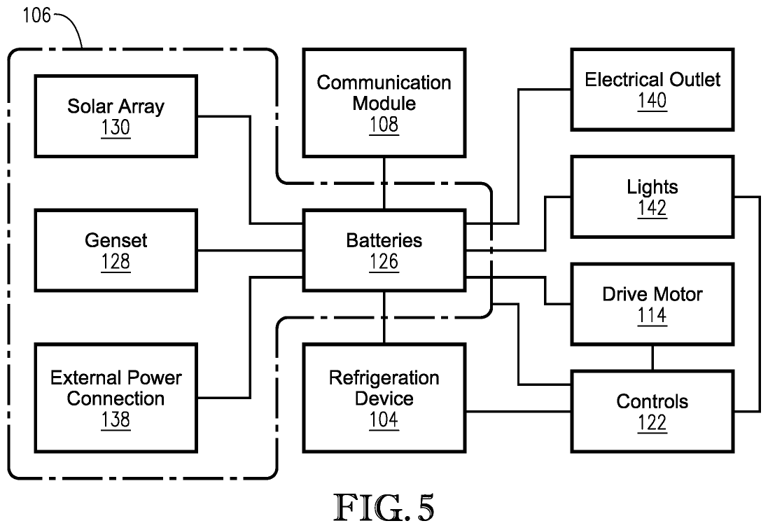

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Turning to the Figures, a medical supply cart system 100 constructed in accordance with an embodiment of the invention is illustrated. The medical supply cart system 100 broadly comprises a cart 102, a refrigeration device 104, a power system 106, and a communication module 108. The medical supply cart system 100 is configured to provide mobile refrigeration for perishable medical supplies.

The cart 102 may include an enclosure 110, a plurality of wheels 112, a drive motor 114, a plurality of lift points 116, a handle 118, a plurality of movable supports 120, and a plurality of controls 122. The cart 102 may be modular and portable.

The enclosure 110 may include a plurality of doors 124A-C and may be substantially metal, plastic, composite material, wood, or any other suitable material. The enclosure 110 may be waterproof or water resistant, weather resistant, and sound dampening.

The plurality of doors 124A-C may be pivotably or slideably connected to walls of the enclosure 110 for accessing the refrigeration device 104, certain components of the power system 106, and in some embodiments the communication module 108, electrical wiring, and electronic components. Three doors 124A-C are shown, but other numbers of doors may be used. The three doors 124A-C are shown on one side of the enclosure 110, but some of the three doors 124A-C or additional doors may be on other sides of the enclosure 110.

The plurality of wheels 112 may be rotatably connected to the enclosure 110 and may be fixed-axle wheels, steerable wheels, or free-turning caster wheels. Some of the plurality of wheels 112 may be driven by the drive motor 114 while some of the plurality of wheels 112 may be free-wheeling. Steerable wheels may be linked to the handle 118 for steering the cart 102.

The drive motor 114 may be drivably connected to some of the plurality of wheels 112 for propelling the cart 102. The drive motor 114 may be powered by the components of the power system 106.

The plurality of lift points 116 may provide safe structure for lifting or hoisting the cart 102. The plurality of lift points 116 may include lift rings, eye hooks, forklift tine channels, and the like.

The handle 118 may be positioned on one end of the cart 102 and may be rigidly connected to the enclosure 110 or may be pivotably or freely linked thereto. In one embodiment, the handle 118 may be linked to steerable wheels of the plurality of wheels 112. The handle 118 may include controls or inputs for controlling the drive motor 114, for steering the cart 102, and/or for controlling various components of the medical cart 100.

The plurality of movable supports 120A-C support the refrigeration device 104 and certain components of the power system 106 and may be slide-out or rotatable trays, drawers, or the like. The plurality of movable supports 120A-C may each be shiftable (e.g., pivotable, rotatable, translatable, or repositionable) between a stored position and an access position. In the stored position, the corresponding refrigeration device 104 or power system component may be completely bounded by walls of the enclosure 110. In the access position, the corresponding refrigeration device 104 or power system component may be positioned at least partially in the enclosure 110 and partially out of the enclosure or entirely out of the enclosure.

The plurality of controls 122 may be positioned near the respective component (e.g., genset, plurality of batteries, or refrigeration device describe below) they control or monitor. For example, some of the plurality of controls 122 may be positioned near the genset, other ones of the plurality of controls 122 may be positioned near the plurality of batteries, while other ones of the plurality of controls 122 may be positioned near the refrigeration device. The plurality of controls 122 may include switches, buttons, dials, knobs, levers, display screens, touchscreens, mouses, keypads, gauges, indicator lights, speakers, and the like. Some of the plurality of controls may be integrated with the enclosure 110, while other ones of the plurality of controls may be integrated with the genset, plurality of batteries, refrigeration device.

The refrigeration device 104 may be configured to retain perishable medical supplies at a lowered temperature or lowered temperature range. In one embodiment, the refrigeration device 104 may be configured to retain some of the perishable medical supplies in a first lowered temperature range and some of the perishable medical supplies in a second lowered temperature range different than the first lowered temperature range. In other embodiments, two refrigeration devices configured to retain perishable medical supplies at different lowered temperature ranges than each other may be used. The refrigeration device 104 may be powered by the plurality of batteries or directly (i.e., not via the plurality of batteries) by the genset or the solar array (described below). The refrigeration device may also be powered directly or indirectly by external power via an external power connection 138, which may be an electrical outlet or other electrical interface.

The power system 106 provides electrical power to the refrigeration device 104, the communication module 108, and other electrical and electronic components and may include a plurality of batteries 126, a genset 128, and a solar array 130.

The plurality of batteries 126 store electrical energy for powering the refrigeration device 104. The plurality of batteries 126 may be lithium, alkaline, or metal hydride batteries, super capacitors, or any other suitable electrical energy storage component. The plurality of batteries 126 may also provide electrical power to the communication module 108, the drive motor 114, auxiliary lights 142, auxiliary power outlets (e.g., electrical outlet 140) for providing auxiliary electrical power, and the like. The plurality of batteries 126 may also be charged by line voltage (via external power connection 138).

The genset 128 may include an engine and generator and may be configured to charge the plurality of batteries 126. The genset 128 may also provide electrical power directly to the refrigeration device 104 (rather than first storing the electrical power in the plurality of batteries). The genset 128 may also provide electrical power to the communication module 108, the drive motor 114, auxiliary lights, auxiliary power outlets, and the like. The genset 128 may be configured to be run on gasoline, diesel fuel, natural gas, propane, or any other suitable fuel. To that end, a fuel tank (such as propane tank 132) may be mounted in, on, or near the enclosure 110 (via support 140) to provide fuel to the genset 128.

The solar array 130 may be mounted near a top of the enclosure 110 and may include a stationary section 134 and a movable section 136 each including one or more solar panels. The stationary section 134 may be rigidly connected to the enclosure 110, while the movable section 136 may be shiftable (translatable, pivotable, rotatable, or a combination thereof) between a stored position and a deployed position. When the movable section 136 is in the stored position, at least one of the stationary section 134 and the movable section 136 may be protected by the other section and/or by the enclosure 110. For example, the movable section 136 may be slid under the stationary section 134 to the stored position and slid out from under the stationary section 134 to the deployed position. In another embodiment, the movable section 136 may be folded over the stationary section 134 to the stored position and unfolded to the deployed position. In this way, the solar array 130 benefits from additional area when in use and can be reduced to a horizontal area corresponding to a horizontal size of the enclosure 110. This also helps protect at least a portion of the solar array 130 when not in use or when less solar power is sufficient. The solar array 130 may also be covered or enclosed by a cover or case when not in use.

The communication module 108 may generally allow components of the medical supply cart system 100 to communicate with, transfer data to, and download software updates, programming, and direct commands from a remote server, cloud service, or other external system, mobile electronic devices, and the like. The communication module 108 may include signal and/or data transmitting and receiving circuits, such as antennas, amplifiers, filters, mixers, oscillators, digital signal processors (DSPs), and the like. The communication module 108 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the communication module 108 may utilize communication standards such as ANT, ANT+, Bluetooth™ low energy (BLE), the industrial, scientific, and medical (ISM) band at 2.4 gigahertz (GHz), or the like.

The medical supply cart system 100 may also include other electrical and electronic components such as connecting wires, busses, converters, inverters, fuses, circuit breakers, and electrical outlets. The medical supply cart system 100 may also include other mechanical components such as valves, pumps, fuel regulators, lubricating systems, cooling systems, heating elements, radiators, and the like.

The above-described medical supply cart system 100 provides several advantages. For example, the medical supply cart system 100 may be used to refrigerate medical supplies such as vaccine dosages including Covid vaccine dosages to provide medical care in remote or mobile environment. The medical supply cart system 100 includes several power options to accommodate local energy source availability. The medical supply cart system 100 may also serve as a “hot spot” via the communication module 108. The communication module 108 may also be used to transmit, to remote or external computing devices, data relating to the refrigeration device 104 and medical supplies such as current temperature and number of medical supplies currently stored, delivered, or used. The medical supply cart system 100 may also be used as an electrical power station or even a mechanical power station via the engine of the genset.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A medical supply cart system comprising:
a cart comprising:
an enclosure; and
a plurality of wheels rotatably mounted to the enclosure for moving the enclosure;
a refrigeration device configured to be positioned in the enclosure and retain perishable medical supplies at a lowered temperature; and
a power source configured to power the refrigeration device.

2. The medical supply cart system of claim 1, the enclosure including a door, the refrigeration device being accessible via the door.

3. The medical supply cart system of claim 2, the cart further comprising a support configured to at least partially translate between an operational position and an access position, the refrigeration device being configured to be positioned on the support so that the refrigeration device retains the perishable medical supplies at the lowered temperature when the support is in the operational position and has improved accessibility when the support is in the access position.

4. The medical supply cart system of claim 1, the enclosure including a door, the power source being accessible via the door.

5. The medical supply cart system of claim 4, the cart further comprising a support configured to at least partially translate between an operational position and an access position, the power source being configured to be positioned on the support so that the power source powers the refrigeration device when the support is in the operational position and has improved accessibility when the support is in the access position.

6. The medical supply cart system of claim 1, the cart further comprising a drive motor configured to drive one of the plurality of wheels.

7. The medical supply cart system of claim 6, the cart further comprising a handle connected to the enclosure for guiding movement of the enclosure, the handle including an input for activating the drive motor.

8. The medical supply cart system of claim 1, further comprising a power system including the power source, wherein the power source is a genset, the power system further including a battery configured to provide power directly to the refrigeration device, the genset being configured to charge the battery.

9. The medical supply cart system of claim 8, the power system further comprising a propane supply and a gasoline supply each configured to power the genset.

10. The medical supply cart system of claim 9, the power system further including a solar panel mounted above the enclosure, the solar array being configured to charge the battery.

11. The medical supply cart system of claim 10, the solar array including a moveable portion configured to be shifted from a stored position to a deployed position to increase electrical output of the solar array.

12. The medical supply cart system of claim 1, further comprising a wireless communication module configured to transmit data associated with statuses and operation of the medical cart for remote monitoring of the medical cart.

13. The medical supply cart system of claim 1, further comprising a wireless communication module configured to transmit communications from an onsite communication device.

14. A medical supply cart system comprising:
a cart comprising:
an enclosure; and
a plurality of wheels rotatably mounted to the enclosure for moving the enclosure;
a refrigeration device configured to be positioned in the enclosure and retain perishable medical supplies at a lowered temperature; and
a power system configured to power the refrigeration device, the power system including:
a plurality of batteries configured to directly power the refrigeration device;
a genset configured to charge the plurality of batteries; and
a solar array configured to charge the plurality of batteries.

15. The medical supply cart system of claim 14, further comprising a communication module configured to be powered by the plurality of batteries.

16. The medical supply cart system of claim 14, further comprising a power outlet connected to the plurality of batteries so that the plurality of batteries are configured to power external electronic and electrical devices via the power outlet.

17. The medical supply cart system of claim 14, the cart further comprising a drive motor drivably connected to one of the plurality of wheels and configured to be powered by the plurality of batteries.

18. The medical supply cart system of claim 14, the enclosure including a plurality of doors, each of the plurality of doors being configured to be opened for accessing one of the refrigeration device, the plurality of batteries, and the genset.

19. The medical supply cart system of claim 18, the cart further comprising a plurality of supports each configured to at least partially translate between an operational position and an access position, wherein the refrigeration device, the plurality of batteries, and the genset are each configured to be positioned on one of the plurality of supports.

20. A medical supply cart system comprising:
a cart comprising:
an enclosure;
a handle attached to the enclosure;
a plurality of wheels rotatably mounted to the enclosure for moving the enclosure;
a drive motor configured be powered by the plurality of batteries and drive one of the plurality of wheels; and
a plurality of supports each configured to be shifted between an operational position and an access position;
a refrigeration device configured to be positioned in the enclosure on one of the plurality of supports and retain perishable medical supplies at a lowered temperature;
a power system configured to power the refrigeration device, the power system including:
a plurality of batteries positioned on one of the plurality of supports in the enclosure and configured to directly power the refrigeration device;
a genset positioned on one of the plurality of supports in the enclosure and configured to charge the plurality of batteries; and
a solar array mounted on a top of the enclosure and configured to charge the plurality of batteries, the solar array including a movable portion shiftable between a stored position and a deployed position; and
a plurality of controls for controlling and monitoring operation of the refrigeration device, the plurality of batteries, the genset, and the solar array.
